(19) United States
(12) Patent Application Publication
(10) Pub. No.: US 2023/0158343 A1
(43) Pub. Date: May 25, 2023

(54) FILTERS FOR VIRUS FILTRATION AND INACTIVATION AND MASK ASSEMBLIES CONTAINING THE SAME

(71) Applicant: Purdue Research Foundation, West Lafayette, IN (US)

(72) Inventors: Helber Antonio Esquivel-Puentes, Lafayette, IN (US); Tanya Purwar, West Lafayette, IN (US); Venkatesh Pulletikurthi, West Lafayette, IN (US); Luciano Castillo, Carmel, IN (US); Ernest Rowland Blatchley, West Lafayette, IN (US); Victor Castano, Queretaro (MX)

(21) Appl. No.: 17/989,647

(22) Filed: Nov. 17, 2022

Related U.S. Application Data
(60) Provisional application No. 63/281,610, filed on Nov. 19, 2021.

(51) Int. Cl. A62B 18/02; B01D 39/20; B01D 39/16; A62B 23/02

(52) U.S. Cl. CPC A62B 18/025; A62B 23/025; B01D 39/1623; B01D 39/2041; B01D 2239/065; B01D 2239/0428; B01D 2239/0442; B01D 2239/0464; B01D 2239/0478; B01D 2239/0618; B01D 2239/1291

(57) ABSTRACT

A mask assembly comprising a face covering portion, a pocket connected to the face portion and positioned to cover a wearer’s nose and mouth, where in a filter is removably inserted into the pocket, the filter comprising a porous hydrophobic and lipophobic layer, a diamond - like carbon coated copper layer, and a non- woven fabric layer. A filter containing at least one porous hydrophobic and lipophobic layer, at least one diamond like carbon coated copper layer interposed between two non-woven fabric layers, and at least one additional non- woven fabric layer. A filter comprising at least one porous hydrophobic and lipophobic layer, at least one diamond - like carbon coated copper layer, and at least one non - woven fabric layer, the at least diamond-like carbon coated layer is between the at least one porous hydrophobic and lipophobic layer and at least one non - woven fabric layer.

### CROSS-REFERENCE TO RELATED APPLICATIONS

The present U.S. Pat. Application is related to and claims the priority benefit of U.S. Provisional Pat. Application Serial No. 63/281,610, filed Nov. 19, 2021, the contents of which are hereby incorporated by reference in their entirety into the present disclosure.

### TECHNICAL FIELD

The present disclosure generally relates to methods and apparatus for filtering viruses and rendering them inactive on a surface. Among other, the disclosure describes methods and articles suitable for virus filtration and inactivation in face coverings such face masks.

### BACKGROUND

This section introduces aspects that may help facilitate a better understanding of the disclosure. Accordingly, these statements are to be read in this light and are not to be understood as admissions about what is or is not prior art.

For centuries, respiratory viruses have been a common cause for initiating epidemics and pandemics worldwide, and wearing of masks has long history associated in preventing their widespread use. For example, in 1918 Influenza epidemic, mandatory masking orders were passed around the globe. In 1980s and 1990s, with the outbreak of SARS and avian influenza, wearing masks was taken a preventive measure to curb the spread of respiratory infections. When H1N1 hit Japan in 2009, wearing masks became a mandatory lifestyle choice and was adapted to normal living for a long time. In 2019, the first case of COVID infection was reported in China due to a respiratory virus called SARS-CoV-2. Research showed that the infection occurs due to airborne transmission when an infected individual exhales the virus into air which also get suspended on common surfaces while talking, coughing or sneezing. The discharged virus can enter a healthy individual’s respiratory tract through inhalation of the micro-droplets in air or through hand-to-nose transmission by touching the infected surface. Several evidence-based studies were conducted to determine the effectiveness of mask mandate, and results obtained showed masks can prevent spreading of virus. The available mask options to general public are KN95 masks, disposable masks, and cloth masks. Although a cloth mask prevents the spread of large saliva droplets in air, its efficiency in preventing virus is questionable. The disposable and KN95 masks have an external layer of spun-bond polypropylene exposed to environment. The second layer is a cellulose-polyester layer. The third layer is a melt-bond polypropylene that is found to be responsible for air filtration. The filtration efficiency of the KN95 is reported to be close to medical grade N95 mask, i.e., up to 95% for 0.3 µm particles and larger, with a mean efficiency of 98%. Previous studies-have shown a filter resistance (R_{f}) of 343 Pa for inhalation and 245 Pa for exhalation, respectively. Another available option known as disposable mask is widely used due of its low air resistance because of lower number of layers and thickness as compared to KN95. Its Rf and collecting efficiency has been characterized as 29 Pa and 32.9 % respectively.

Both KN95 and disposable masks are efficient in virus filtration, however, they need regular replacement because of their short lifetime and these masks get easily clogged due to dust. A study-showed the need for safe disposal due to stable persistence of virus on these masks, for days. In terms of breathability, it is easier to breathe through disposable mask as compared to KN95 because of multiple and thick layers in it. Hence, in this study, we propose a novel filter mask to achieve better breathability, longer life with re-usability, and with better filtration efficiency.

Hence, there is an unmet need for a filter mask to achieve better breathability, longer life with re-usability, and better filtration efficiency.

### SUMMARY

A mask assembly is disclosed. The mask assembly contains a face covering portion, a pocket connected to the face portion and positioned to cover a wearer’s nose and mouth, where in a filter is removably inserted into the pocket, the filter comprising a porous hydrophobic and lipophobic layer, a diamond - like carbon coated copper layer, and a non- woven fabric layer.

A filter is disclosed. The filter contains at least one porous hydrophobic and lipophobic layer, at least one diamond like carbon coated copper layer interposed between two non-woven fabric layers, and at least one additional non- woven fabric layer.

Another filter is disclosed. The filter contains at least one porous hydrophobic and lipophobic layer, at least one diamond – like carbon coated copper layer, and at least one non -woven fabric layer, the at least diamond-like carbon coated layer is between the at least one porous hydrophobic and lipophobic layer and at least one non - woven fabric layer.

### BRIEF DESCRIPTION OF DRAWINGS

While some of the figures shown herein may have been generated from scaled drawings or from photographs that are scalable, it is understood that such relative scaling within a figure are by way of example, and are not to be construed as limiting.

FIG. 1 is a schematic representation of the layers of a proposed Hy-Cu filter of this disclosure.

FIG. 2 shows contact angle of artificial saliva droplet on external layer of masks and filter.

FIG. 3 shows 3-layer and 5-layer configuration of Hy-Cu filter of this disclosure.

FIG. 4 shows filter and mask samples employed in experiments leading to this disclosure.

FIG. 5 shows a schematic representation of virus filtration test set up employed in testing filters of this disclosure.

FIG. 6 shows is representation of physical and bio-chemical action of layers of a filter of this disclosure.

FIG. 7 shows set-up used for pressure resistance test simulations in ANSYS FLUENT

FIG. 8 shows comparison of pressure resistance vs velocity for different filter samples of this disclosure.

FIG. 9 shows comparison of normalized pressure resistance vs Reynolds number for Hy-Cu 5 layer of this disclosure.

FIG. 10 shows comparison of normalized pressure resistance vs Reynolds number for Hy-Cu 3 layer of this disclosure.

FIG. 11 shows comparison of normalized pressure resistance vs Reynolds number for surgical mask.

FIG. 12 shows Comparison of normalized pressure resistance vs Reynolds number for KN95.

FIG. 13 shows Virus Log Reduction comparison for Hy-Cu 5 layer filter and Surgical mask

FIG. 14 shows the overall quality factor for Hy-Cu 5 layer and Surgical mask.

FIG. 15 shows performance of single non-woven layer in virus filtration.

FIG. 16 shows virus inactivation comparison - DLC vs NO DLC after 2 hours.

FIG. 17 shows a mask assembly according to this disclosure.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates.

The COVID-19 pandemic has caused a multi-scale impact on people from all walks of life. This situation of crisis has created a need to develop knowledge, seeking solutions to mitigate the negative effects of COVID-19 virus, on the humankind. One of the particular prevention measures is the use of face mask to reduce the spread of virus since the virus gets transmitted through micro droplets of saliva. The current technology of masks prevents the passage of micro-droplets to certain extent.

However, filtration alone is not a sustainable solution because of the environment pollution the masks create as they are thrown out due to their short lifetime. With the extended periods of usage masks during strenuous activities, it is required to have a better breathability to prevent long term effects on lungs. In this disclosure is described a filter (designated as HyCu) with an embedded virus inactivation and better breathability without compromising the virus filtering efficiency. The filter HyCu of this disclosure contains multiple layers. For purposes of this disclosure, a layer of the filter in a mask closest to the ambient atmosphere and farthest from the person wearing the mask containing the filter is termed external layer; the other layers of the filter are termed internal layers. The external layer of a filters of this disclosure is made up of polypropylene layer(in this disclosure and in accompanying drawings polypropylene is sometimes designated as PP) coated with a specially designed hydrophobic and lipophobic solution which helps in rejecting saliva-droplets carrying the virus. The internal layers include a copper (Cu) mesh coated with diamond-like carbon (DLC) . In this disclosure, the layer comprising copper (Cu) mesh coated with DLC is proven to be capable of virus inactivation. The other internal layers are non-woven layers for exposing virus from small micro-droplets escaped from external propylene layer. The filter of this disclosure is designated, for the purposes of this disclosure, as Hy-Cu because of the hydrophobic and virus inactivation capabilities due to the hydrophobic coating and the coated copper layer contained in the filter. The breathability of HyCu is tested and compared with widely used disposable masks and KN95 masks both experimentally and numerically. The results show that the HyCu offers at least 10% less air resistance as compared to conventional disposable surgical mask and KN95 mask. The experimental results on virus inactivation and filtering using MS2 bacteriage (similar protein structure as SARS-CoV-2) showed that HyCu filter has 90% filtering efficiency and 99% virus inactivation in a duration of 2 hours.

One filter of this disclosure comprises an external layer that is a spun-bond PP, coated with nano-engineered hydrophobic and lipophobic coating which is a water-based omni-phobic solution. The coating with hydrophobic properties rejects the aerosolized micro-droplets of saliva and mucous, a common carrier of the virus. The lipophobic property of the coating helps in preventing the virus from hosting on the fibers of the external layer, since the outer envelope of the virus structure like most respiratory viruses is lipidic in nature. One of the internal layers is a DLC coated copper mesh and other internal layer is a non-woven layer to trap the escaped particles. The copper is well known for its anti-microbial properties and capability to attack and deactivate pathogens citewarnes2015human. The deactivation mechanism works when the pathogen comes in contact with the copper surface, the metal surface releases ions that alter the morphological structure of the pathogen, moreover these ions can break through the membrane of the bacteria or virus leading to inactivation and decontamination over time. Studies have shown that when the viruses and bacteria pass through masks, the pathogens can be trapped in different layers of the mask, and the virus can survive in between the fibers and the layers for days making it hazardous to be dispose along with non-hazardous waste. A recent study found the Diamond-Like Carbon (DLC) coating doped with zinc oxide is a potential material that could be used for pathogen rejection and deactivation. A property of the DLC is its low surface roughness, in addition to very high resistance to wear and tear, pH sensitivity, hydrophobicity, and super-hydrophobicity in some cases. In a particular case when the DLC is doped with ZnO particles, Zn ions are released causing important antimicrobial actions in infectious environments with a pH in the range between 7.4 to 5.4. The human coronavirus structure has an outer lipid layer that holds the RNA together. This lipid envelope is susceptible to mechanical and environmental stress. The rupture of this protective lipid layer exposes the vulnerable RNA of the virus.

In this disclosure, the performance of the proposed mask is analyzed, the filter resistance, virus inactivation ability and virus filtering efficiency were evaluated using experimental techniques. The experimental setup and methodology for finding R_{filter} of a mask of this disclosure is also described in this disclosure A computational study was used to expand the experimental results in wide range of the flow rates by modeling the filter as porous media. The results on experimental and computational observations are discussed in this disclosure.

Materials and Methods leading to this disclosure are described below:

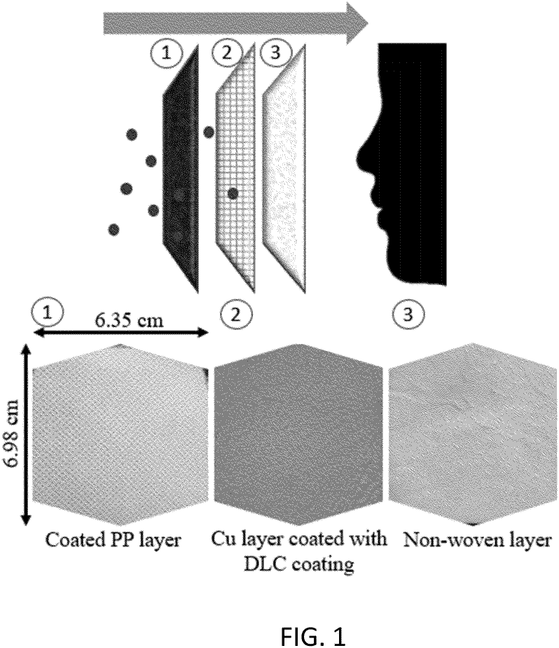

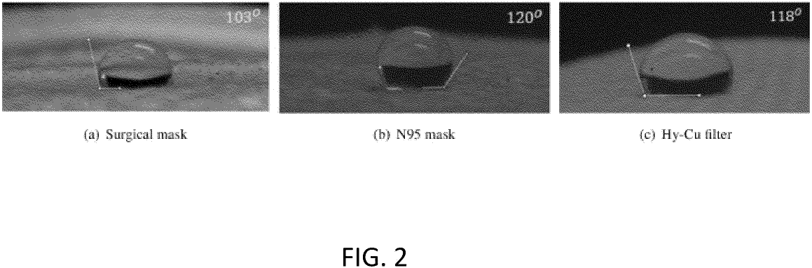

Filter Fabrication and Design: In studies leading to this disclosure, a filter of this disclosure is configured as a composition of three layers, the external layer, the middle and the inner layer as shown in FIG. 1. It should be noted that, throughout this specification and accompanying drawings, while the layers comprising the filter are shown to be separate, as a practical matter in the fabrication of the filter, the layers are in contact in the sequences described. Further, any dimensions indicated for the layers (such as in FIG. 1) are to be understood as one example and in practice the dimensions including thickness will be chosen as required and meaningful in a given application. The external layer is a spun-bond polypropylene layer shown as coated polypropylene layer and designated as 1 in FIG. 1. This layer is closest to the atmosphere. This layer, called external layer or outermost layer is coated with nano-engineered omniphobic water-based solution that is hydrophobic and lipophobic in nature. The layer is coated under controlled conditions using electrostatic spray deposition technique, ensuring uniform layer of hydrophobic and lipophobic coating. This increases the surface wettability/ hydrophobicity of the outermost layer. FIG. 2 shows the contact angle of artificial saliva droplet on the outermost hydrophobic layer of Hy-Cu filter, surgical mask, and N95 mask. The airborne transmission of coronavirus depends on the respiratory particles hosting on saliva or mucous aerosols/ micro-droplets. The main function of the omniphobic coated layer is to repel these micro droplets. Human coronavirus is a single stranded RNA with a viral envelope made from a layer of lipids, that protects the virus when it is outside of a host cell. In the case where the virus particle reaches the surface of the exposed external layer, the lipophobic nature of the coating on its surface, will have a tendency to prevent the virus from further entering the filtration system. The middle layer, designated as 2 in FIG. 1 is s a diamond like carbon (DLC) -coated copper mesh with a pore size of about 200 micrometers. The coating was prepared by the company Technometals, Dayton. OH. Hydrogenated carbon and Diamond-like carbon can be obtained using multiple techniques like chemical vapor deposition (CVD) or physical vapor deposition (PVD), for this study was use the PVD technique. The DLC coating on the copper mesh has a thickness in the range of 1 µm to 5 µm. PVD, a plasma assisted physical vapor deposition technique can be described as the attack with accelerated ions on a material known as a target. This bombardment process is produced by the discharge of an electric arc between an anode and a cathode that is in an atmosphere of an ionizable gas (with low ionization potential) such as Argon, which can produce plasma rich in ions with the application of a certain activation voltage. The bombardment of the ions on the target which causes the detachment of the atoms that make up the target. A carbon-based target is pulverized by a electrical discharge applied between two electrodes. The carbon atoms are ionized in order to make them impinge the surface of the substrate, in this case the copper mesh. The innermost non-woven layer, designated as 3 in FIG. 1 close to the mouth of the person wearing the mask is made of light polypropylene fabric, and has good air permeability, is breathable, non-toxic and non-irritating. This non-woven interfacing is characterized based on mass per unit area. These textiles have fibers that are held together by hydro-entanglement with fairly random mechanical intertwining of the filaments. In a non-woven fiber, the particulate removal takes place according to different mechanisms depending on particle size, namely, straining or sieving, inertial impaction, interception and Brownian diffusion. Different grades of non-woven layers affect the filtering efficiency. Higher the mass per unit area, better filtration might be evident.

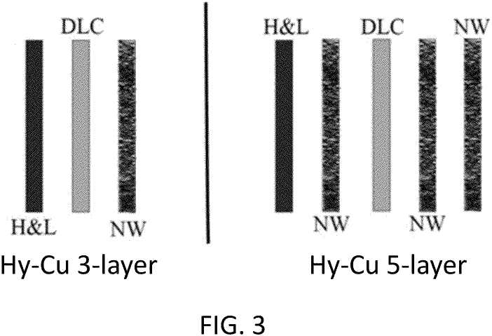

Different configurations of Hy-Cu was prepared to test for pressure resistance efficiency, as well as virus filtration efficiency. For testing pressure resistance efficiency, a 3-layer and 5-layer configurations, tested as shown in the FIG. 3, were tested.. Referring to FIG. 3, in 3- layer arrangement, there was hydrophobic and lipophobic layer (outermost, exposed to atmosphere) designated as H&L followed by DLC- coated copper layer (designated as DLC in FIG. 3,), and non-woven layer (innermost, close to mouth). Again, referring to FIG. 3, in 5-layer configuration, there was hydrophobic and lipophobic layer (outermost), non-woven layer H&L, followed by DLC coated copper layer (middle), and 3 non-woven layers NW, as shown, with one of the NW layers, the one shown rightmost in FIG. 3 will be closest to mouth of the person wearing the mask. In the virus filtration test, 5-layer configuration shown in FIG. 3 was used. In addition to these tests, a virus filtering test bed was used to characterize the non-woven layer with different grade, from Hy-Cu filter and commercially available disposable mask.

The experimental studies leading to the disclosure are described below:

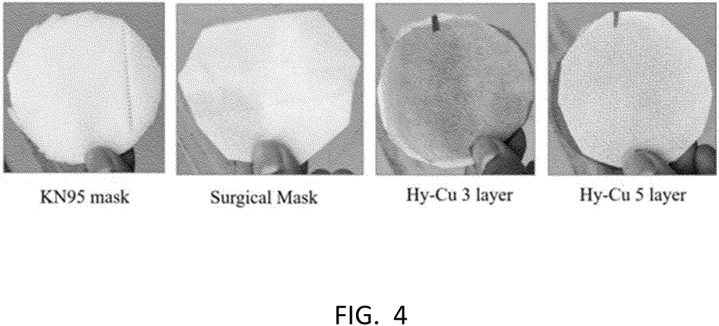

Pressure resistance test: Literature mentions ranges of velocities based on human respiratory actions of breathing at about 1 m/s, talking at 5 m/s, coughing at 10 m/s and sneezing at 20 m/s. An experimental setup was designed to measure the pressure resistance offered by a mask or a filter at a wide range of flow velocities such as, 0.5 m/s, 1.9 m/s, 3.5 m/s, 7.5 m/s, 9 m/s, 11 m/s, 12.5 m/s, 14.5 m/s. These velocities are selected, keeping in mind the human respiratory inhalation and exhalation, under different circumstances like breathing, talking, running or exercising, coughing, sneezing and so on. The filter/ mask samples tested for pressure resistance are KN95 mask, Surgical mask, Hy-Cu 3-layer filter, Hy-Cu 5 layer shown in FIG. 4. A DC voltage blower with a maximum flow rate of 178 m³/hr is used to create the air flow through the filter. Reducers are used to decrease the blower outlet diameter of 0.1 m to 0.025 m. A ball valve is used to control the flow rate for various air speeds and two flanges are used to fix the filter or mask in place. A digital pressure transducer with a pressure range of 0-1000 Pa, and two pressure probes are inserted at a distance of 0.5 inch from the filter, on both upstream and downstream, is used to measure the pressure drop across the filter at given range of velocities. A handheld vane anemometer is mounted at the downstream of the flow to measure the flow rate. A National Instruments’ Data Acquisition (DAQ) system is used to record data from the pressure transducer to the computer. The length of the pipe is about 2 m to achieve fully developed flow for given Reynolds number observed in the flow, keeping in mind some experimental constraints. Pressure resistance vs velocity trends are analyzed from data collected, to determine the breathability of the filters and masks.

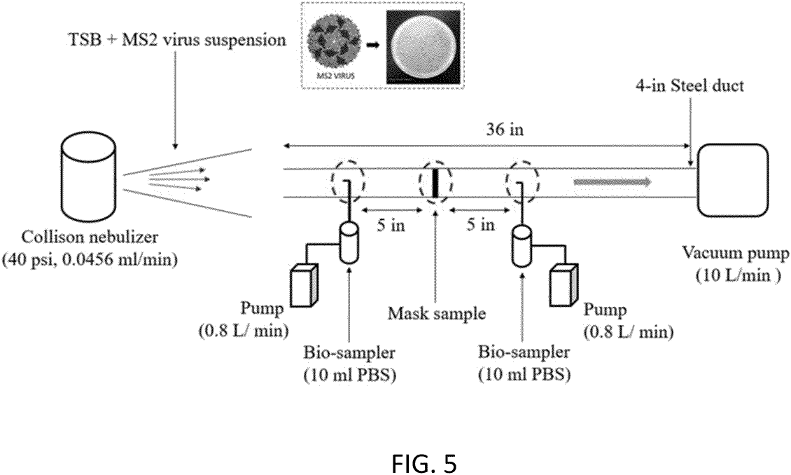

Virus Filtration test: For virus filtration test, bacteriophage MS2 (ATCC 15597-B1) and Escherichia coli C-3000 (ATCC 15597) are used as the test virus and virus host bacteria, respectively. Morphologically, MS2 is a non-enveloped, icosohedral, positive-stranded RNA virus. MS2’s small size, and lack of outer lipid envelope makes it resistant to chemical and environmental resistances. It is used as a surrogate virus for human coronavirus in the current study. The filter/ mask samples tested for virus filtration are disposable medical mask and 5 layered Hy-Cu filter. The idea is to test the filter against commercially and widely available disposable masks with comparable pressure drops as observed in pressure resistance test. Also, a single non-woven layer from each sample, namely disposable medical mask and Hy-Cu filter, is separately tested on this test bed with same experimental conditions to check the concentration of virus retained on the non-woven layer after the run. This is to understand the filtration efficiency of different layers for better comparison. FIG. 5 shows a schematic representation of virus filtration test set up used in these experiments leading to this disclosure. The test bed used contained a Collison nebulizer (CH Technologies Inc.) that sprays aerosol of MS2 bacteriophage suspension mixed with tryptic soy broth (TSB). A nebulizer was used which can produce aerosols varying from 0.05 µm to 20 µm at 40 psi pressure and 0.0456 ml/min flow rate. The nebulizer is run for 15 minutes for every test case. The virus infused aerosol enters a 4-inch duct, 36-inches long, with diverging inlet to prevent back flow of the micro-droplets from the nebulizer. At 5-inch distance, upstream and downstream of the filter, two SKC fritted bio-samplers are placed for collection of virus sample before and after the filter. The bio-samplers contain 10 ml of phosphate buffer solution (PBS) for virus aerosol collection and the bio-sampler pumps run at 0.8 L/min. The fritted samplers are run one at a time to prevent interference in sampling and avoid non-uniform particle spread through duct cross-section, due to the wake region of the probe heads of the bio-sampler.

For plaque assay analysis of the collected virus sample, soft tryptic soy agar (TSA) is mixed in DI water, and the solution is poured into a Petri dish and allowed to sit until solidified. The collected virus sample and host bacteria are mixed and poured into the Petri dish and incubated overnight at 36° C. The number of plaques that appear on the plate are counted and the viral log reduction in the two sample cases, is calculated using the equation 1:

$$L R V = l o {g}_{10} P {F}_{d o w n s t r e a m} / P F {U}_{u p s t r e a m}$$

where, LRV is the virus log-reduction value, the numerator is the number of plaque forming units (PFU) on the nutrient agar plate after incubation from the virus sample collected downstream of the filter, and the denominator is the number of plaque forming units on the nutrient agar plate after incubation from the virus sample collected upstream of the filter.

The virus filtration efficiency-assuming consistent virus size and considering the droplet distribution from Collison nebulizer between 0.05 µm to 20 µm is defined using equation 2:

$${η}_{f} = 1 - \left[P F {U}_{d o w n s t r e a m} / P F {U}_{u p s t r e a m}\right]$$

Overall quality factor -of the filter/ mask is evaluated for the various velocity cases and associated pressure drop using the equation 3:

$${q}_{f} = l n \left[1 / 1 - {η}_{f}\right] / Δ P$$

A single non-woven layer from each sample, namely disposable mask and HyCu filter, is separately tested on this test bed with same experimental conditions to check the concentration of virus retained on the non-woven layer after the 15 minutes run. This is to understand the filtration efficiency of different layers of each sample for better comparison.

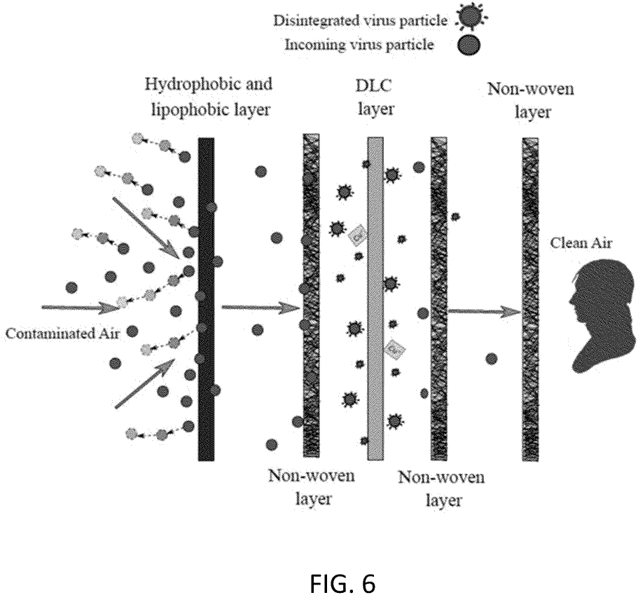

FIG. 6 shows physical and bio-chemical action of layers of a 5-layer filter of this disclosure. In this figure the configuration of the five layers is presented, the only difference with the three-layer model is that here two additional non-woven layers are included. FIG. 6 illustrates how the virus particles are being trapped by the external layers, once the remanent reaches the Cu-coated layer with DLC the inactivation mechanism is engaged and eliminates the virus particles by releasing the metallic ions.

Virus Inactivation test: The virus filtration test bed is used for testing the efficiency of the middle DLC layer, that has properties of inactivating viral pathogens that come in contact with it as discussed earlier and shown in FIG. 6. For this, the Hy-Cu filter with and without the DLC coated copper mesh is tested for the same well controlled experimental conditions as discussed earlier. Two pieces of 4 cm by 2 cm is cut from the main sample (for both HyCu with and without DLC) after the run. One piece is tested at time t=0 hrs, and another piece is kept in safe laboratory environment for 2 hours, after which it is tested for time t=2 hrs. Hence, samples from HyCu with and without DLC coated copper mesh are tested at t=0 hrs and t=2 hrs. This is to quantify the virus inactivation in the filter system with and without the DLC layer.

Computational Study: The fibrous filter/ mask is numerically modeled as porous zone, in ANSYS Fluent. Porosity of the fibrous filter is one of the most crucial parameters strongly affecting both collection efficiency and pressure drop for a mask that behaves like porous media (ANSYS user guide: Porous Media Conditions). Energy is lost in terms of viscous and inertial resistance when a flow passes through porous media. In such flows, for a given energy input (measured as pressure drop), it is useful to be able to predict the flow rate or to be able to predict pressure drop from given flow rate. In literature, a general physical model was suggested that total pressure drop or flow resistance is a sum of viscous losses and inertial losses, like a truncated power series for pressure drop as a function of velocity:

$$- ∇ P = {C}_{1} + {C}_{2} {U}^{2}$$

In modeling of porous media, a momentum source term (S) is added to the Navier-Stokes equation for a fluid flow as equation5:

$$\partial / \partial t \left(ρ {U}_{i}\right) + \partial / \partial {x}_{j} \left(ρ {U}_{i} {U}_{j}\right)$$

$$\begin{matrix}= - \partial p / \partial {x}_{i} + \partial / \partial {x}_{j} \left[μ \left(\partial {U}_{i} / \partial {x}_{j} + \partial {U}_{j} / \partial {x}_{i}\right)\right] - \\ \left(2 / 3\right) μ \left(\partial {U}_{i} / \partial {x}_{j}\right) I + ρ g\end{matrix}$$

$$+ S$$

The source term is composed of viscous loss term and inertial loss term. It is non-zero in the porous zone and zero outside the porous zone and written as equation 6

$$S = - \left[{C}_{1} U + \left(1 / 2\right) ρ {C}_{2} U U\right] \left(1 / t\right)$$

This helps in modeling of the porous media and the additional energy losses due to its presence in the flow. There are dominant viscous losses at lower Reynolds number while dominant inertial losses at higher Reynolds number. For laminar flows, Darcy’s law is a classical equation that describes the flow of a fluid through a porous medium:

$$\frac{Δ P}{L} = \frac{μ U}{α}$$

This shows that at lower Reynolds number, where the viscous losses are dominant, the pressure drop varies linearly with velocity. For lower flow velocities, the constant C2 can be considered zero. At high flow velocities, the constant C2 gives the loss coefficient per unit length in direction of flow, and hence the pressure drop is written as a function of dynamic head. The porous coefficients C1 and C2 can be determined from the experimental data that is obtained in the form of pressure drop against velocity.

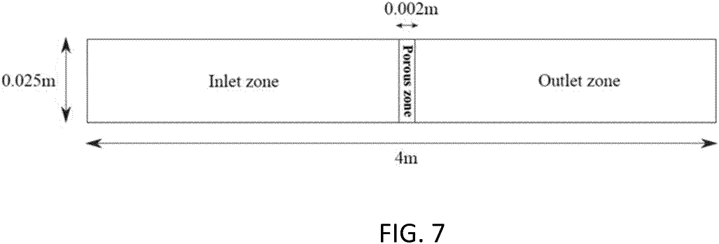

The numerical modelling in current study involves a simple pipe flow, with inlet zone, porous zone and outlet zone as shown in FIG. 7. The viscous model used in ANSYS FLUENT, employed here, is standard kε with standard wall functions. The fluid material is Air. For boundary conditions, the inlet is a velocity inlet and outlet is a pressure outlet. In the cell zone conditions, the porous zone is characterized based on viscous and inertial resistance values obtained from experimental data. The absolute pressure values are obtained as area weighted average right before and after the porous zone of thickness of 2 mm, to calculate the pressure drop. For grid independent study, pressure drop is chosen as the parameter and four meshes of different grid sizes (number of elements) namely, M1 (50 k), M2 (100 k), M3 (250 k), and M4 (400 k) are compared. Pressure drop value changes 0.0031% (almost negligible) between M3 and M4 and so we chose M3 for accuracy and computational time. The pressure drop results from the ANSYS numerical modeling are compared with the experiment.

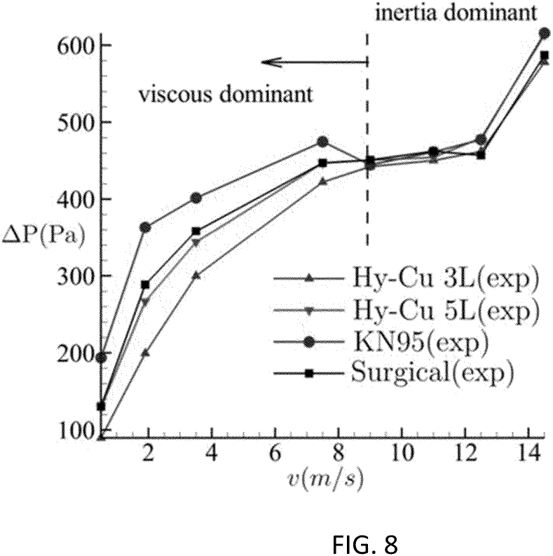

In this disclosure, both experimental analysis, namely pressure resistance test and virus filtration efficiency test are described based on experiments performed in terms such as an individual wearing the mask or filter is subjected to the virus laden flow from outside. FIG. 8 shows the experimental pressure resistance vs velocity of the KN95 mask (similar to N95 mask), disposable surgical mask, novel filter Hy-Cu 3 layers and novel filter Hy-Cu 5 layers configuration. The pressure drop across the KN95 mask is much higher as compared to all other cases of mask and filter. Hy-Cu filters offers a resistance ratio, (ratio of filter resistance to disposable mask) ≤ 0.9 for flow velocities less than 10 ms-¹, which is typical for most human activities such as breathing (including physical activities), talking and coughing.

At higher velocities, the filter of this disclosure has comparable resistance as the disposable mask. It can be noted that KN95 mask has higher pressure drop compared to both surgical mask and novel filter, at higher velocities. The viscous and inertial resistance coefficients namely, C1 and C2 are obtained by comparing the trend-line from pressure drop vs velocity plots with equation 6 and 7. The porous coefficient values are tabulated in Table 1.

TABLE 1

Viscous (C) and Inertial (C) resistance values from experimental data

| Mask Sample | Viscous dominant (linear) region | | Inertia dominant (parabolic) region | |
|---|---|---|---|---|
| | C1 | C2 | C1 | C2 |
| Hy-Cu 5 layer | 1980491895 | 0 | 1512576859 | 788.8163265 |
| Hy-Cu 3 layer | 1792006708 | 0 | 1596198994 | 1083.265306 |
| Surgical mask | 2016294019 | 0 | 1639882616 | 1154.204082 |
| KN95 mask | 2222247065 | 0 | 1489631079 | 731.0204082 |

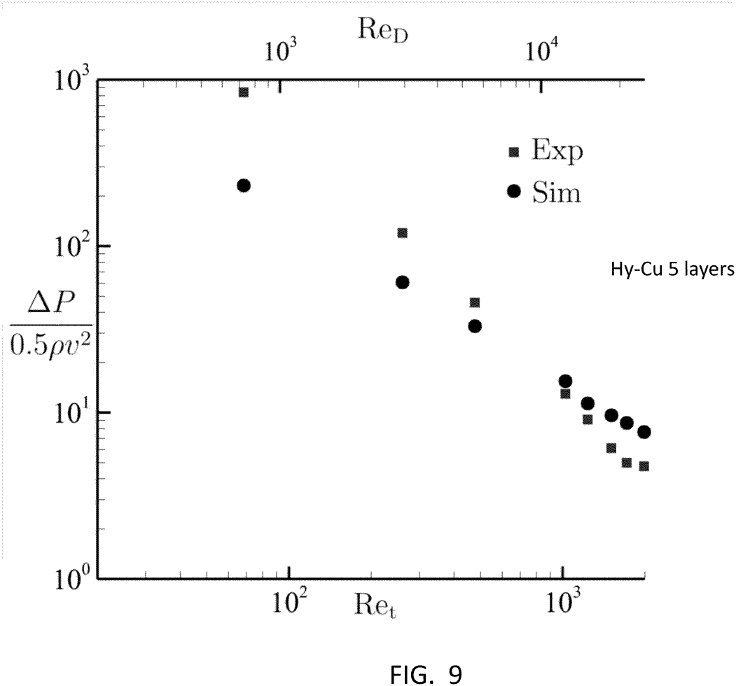

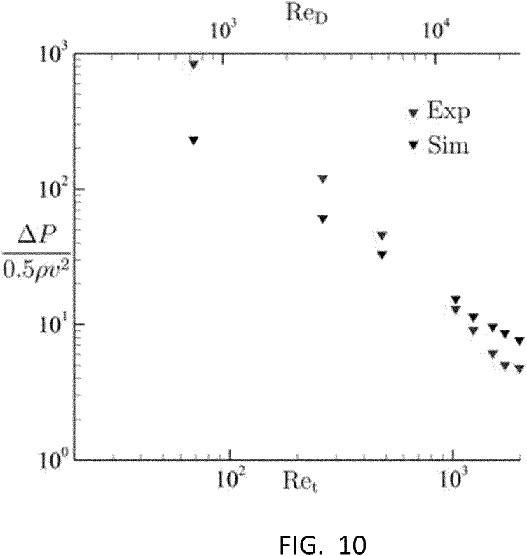

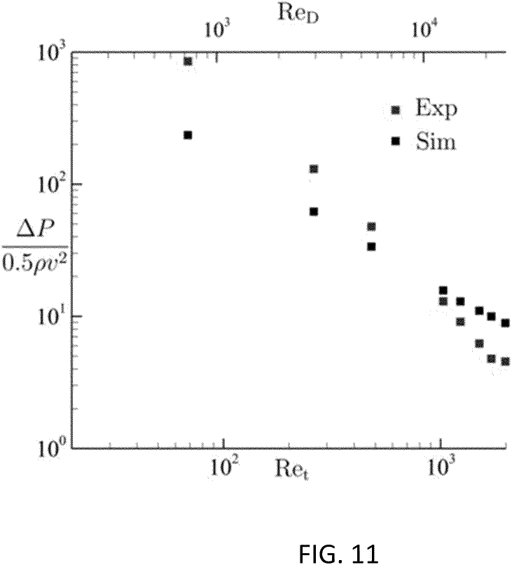

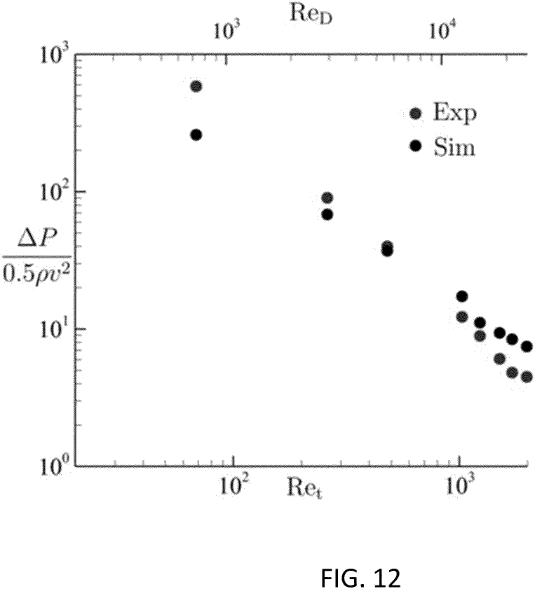

From FIG. 8, it is observed that the data trend can be divided into viscous and inertial dominant region, viscous being the linear part at low velocities, while inertial at higher velocities. For the linear region, C₂ is set at zero in the cell zone conditions in Fluent. The results for Fluent simulations as compared to experiments is represented in the plot ref for each sample case. The pressure drop on y-axis is normalized with dynamic pressure head (0.5_{ρv}²) while the velocity is normalized as Reynolds number, where ReD and Ret represent the Reynolds number with respect to the pipe diameter (25.4 mm) and porous media thickness (2 mm) respectively. The simulation results as shown in FIGS. 9, 10, 11 and 12_show a good agreement with experimental data with an error of ≤ 30% for the wide range of Re. We find a general common trend in all the four cases of samples.

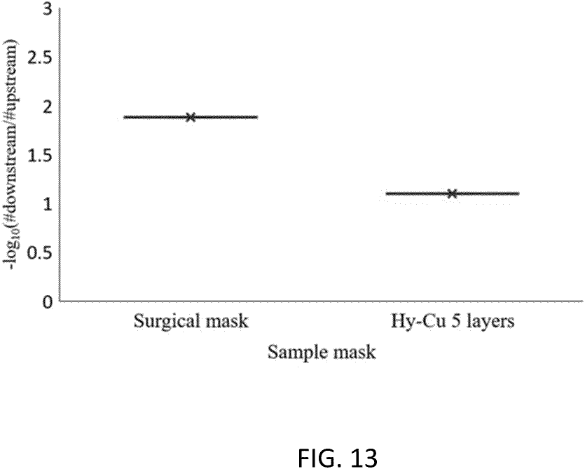

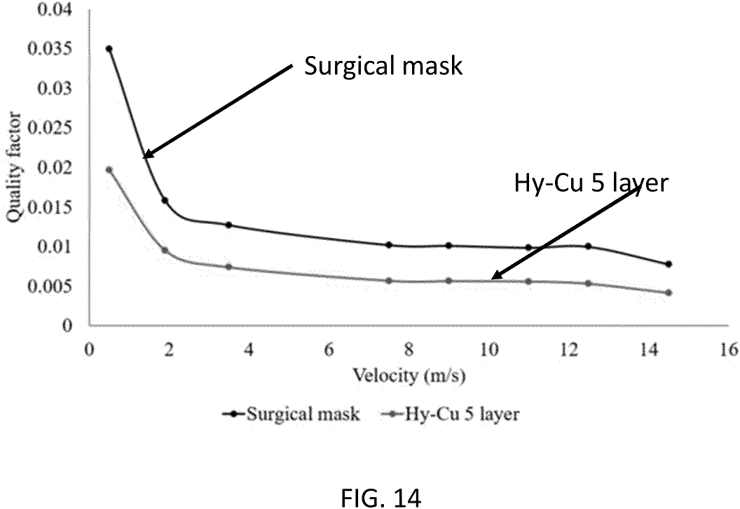

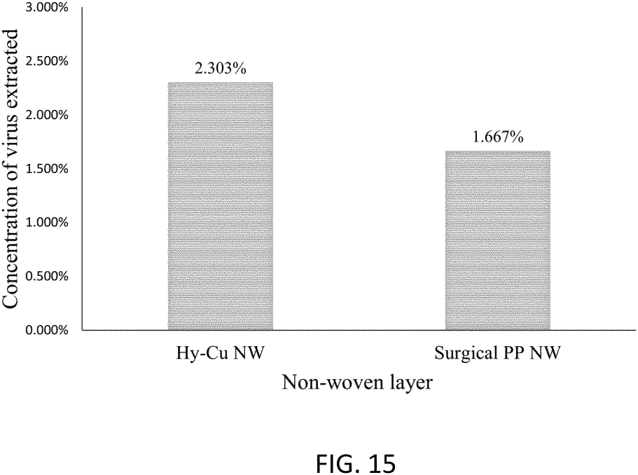

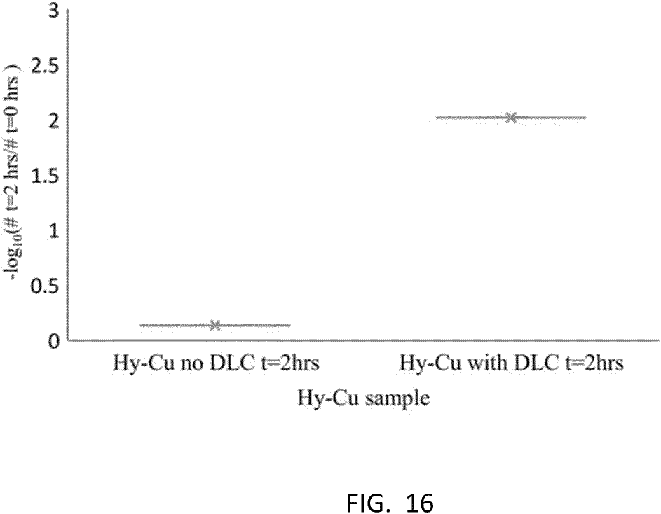

From the virus efficiency test bed, the virus log reduction value is represented in the plot in FIG. 13. For Hy-Cu 5 layers, the virus filtration efficiency is 90% while for medical grade disposable mask, is 95% when the virus suspended aerosol droplets flow through the samples for 15 minutes. The overall quality factor, q_{F} (eq0.3) of the disposable surgical mask is about 1.5 times that of the novel filter through the range of velocities as shown in the plot of FIG. 14. On comparing the non-woven layers from each sample as shown in FIG. 15, we obtain that the non-woven layer used in HyCu filter has 2.3% virus concentration retention as compared to the non-woven in the disposable mask that shows 1.6% of viral concentration after the 15 minutes of experiment run. The plot in FIG. 16, shows virus inactivation efficiency in the presence of DLC coated copper mesh as the middle layer. The HyCu filter with DLC is observed to have 99% viral inactivation efficiency as compared to filter with no DLC that shows « 90% of viral inactivation over a duration of 2 hours.

These experimental and computational studies show that the novel Hy-Cu filter has better pressure resistance efficiency as compared to other medical grade masks, in terms of breath-ability across the filter and can be used for longer, since the lower pressure drop across the filter media prevents the early formation of cake layer of dust and other unwanted particulate in air, that eventually clog any filter/ mask. In terms of efficiency against the MS2 virus, the novel Hy-Cu filter shows lower efficiency and overall quality factor, as compared to the disposable medical mask. The non-woven layer is a key factor in the straining, interception, inertial impaction and diffusion processes that makes the particles cling to the fibers subjecting them to the DLC copper layer, leading to eventual inactivation. The results show that the non-woven layer in Hy-Cu filter have better filtration efficiency as compared to medical mask. The virus inactivation for Hy-Cu with DLC shows orders of magnitude difference in virus concentration reduction as compared to no DLC condition. The overall lower efficiency of Hy-Cu can be attributed to the fact that the layers of Hy-Cu filter are not combined together for tests in laboratory conditions without any proper infusion between the layers which is the case for the disposable masks being compared, here commercial melt-blown processes are used for creating the mask system. The polypropylene combined with non-woven that is present in all three layers of disposable medical masks can also be a reason for its higher overall efficiency against virus. Also, there is no electrostatic charge applied to the Hy-Cu filter layers for the experiments in this work.

This disclosure describes a filter design that can be attached to any cloth mask or scarf. The novelty of the design lies in the use of a layer coated with in-house hydrophobic and lipophobic coating to repel the coronavirus with outer lipidic envelope and the pH sensitive diamond like carbon coating on copper mesh, that can lead to virus inactivation process, due to the anti-microbial properties. These layers along with non-woven layer can be arranged in different configurations. In this disclosure are described experimental and computational test of the 3-layer and 5-layer configuration of Hy-Cu filter for pressure resistance, and compared it to medical grade disposable masks. The Hy-Cu 3 layer is highly breathable, followed by Hy-Cu 5 layer, then surgical mask, and KN95 mask, over wide range of velocities that involve almost all human activities. The experimental data is used to extract viscous and inertial resistance values that help in characterizing the filter fibers modelled as porous media for numerical modeling of such flows in ANSYS Fluent. These values can be used to create more realistic cases of simulations for masks by designing geometries with the an-isotropic fiber arrangement unlike the current study where the porous zone is designed as a simple cylinder. The simulations are in good agreement with experimental data with ≤ 30% error, in this study.

In terms of virus filtration efficiency, the disposable mask and Hy-Cu 5–layer filter is subjected to aerosol droplets carrying MS2 virus, in well controlled experiments. The novel filter shows 90% efficiency and disposable surgical mask shows 95% efficiency. The Hy-Cu filter performs very well in terms of virus inactivation over a period (that is , a duration) of 2 hours, in the presence of DLC layer, observing 99% efficiency. The non-woven layer has better efficiency in virus filtration as compared to the non-woven from disposable mask. The filter has very high performance in terms of inactivation, breathability, and re-usability as well as virus filtration. The novel Hy-Cu filter is an environmentally judicious and efficient substitute to the disposable masks currently used. The flexible design characteristics and reusable property, makes this a unique contribution to combat the current and future pandemic phases.

In practical use the masks and filters described in this disclosure typically require connectors and frame as described in U.S. Pat. Application 17 / 223,724 by Castillo et. al, published on Oct. 14, 2021 as U.S. Pat. Application Publication US 2021/0315293 A1 entitled “WEARABLE FACE MASK WITH ANTI - VIRAL FILTRATION MEDIA”. The contents of this publication are incorporated herein by reference in their entirety into this disclosure. The masks and filters can be combined with the teachings of this publication to make mask assemblies comprising the filters of this disclosure and the connectors and frames as described in the said patent application publication. Accordingly, it is an objective of this description to disclose mask assemblies configured to be worn by individuals by using the connector and frames described in this publication and employing the masks and filters of this disclosure.

It should be recognized that the pore size for the copper mesh employed in the fabrication of the filters of this disclosure is in the range of 100-200 micrometers. The thickness of DLC coating on the copper mesh is in the range of 1-5 micrometers thus making the pore size of the DLC coated copper mesh will be in the range of 95-199 micrometers. Also, it should be noted that the average pore size for the hydrophobic layer sand the non-woven fabric layers of this disclosure is in the range of 5-15 micrometers.

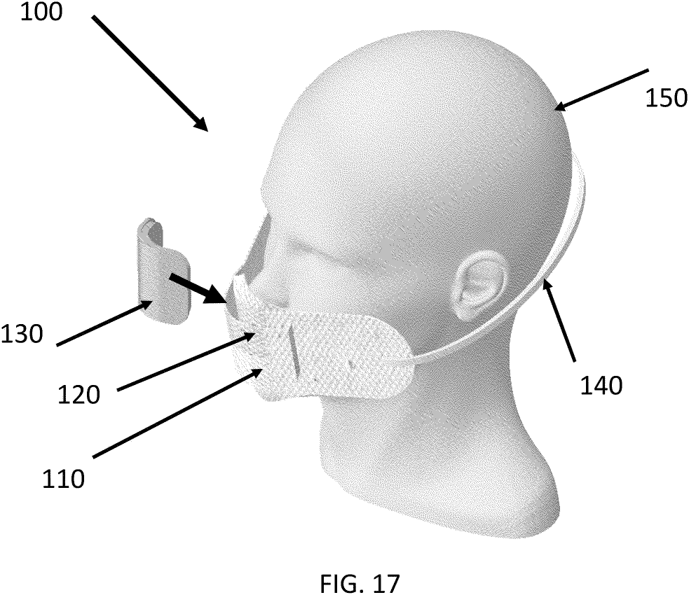

FIG. 17 shows one exemplary embodiment of a mask assembly that can be constructed from the above description. Referring to FIG. 17, 100 is a mask assembly that can be worn by human being schematically represented as 150. The mask assembly has a face covering portion 110 containing a pocket 120 capable of receiving a filter 130. The face covering portion 110 and the pocket 120 can be made by a material such as but not limited to polypropylene. The face covering portion 110 is operationally connected to the human being 150 by a connecting mechanism 140 which can be any advantageous system known in the art for mask assemblies. The filter 130 can be one of the Hy-Cu filters of this disclosure. In particular, the filter 130 can be the 3-layer filter depicted in FIG. 1 containing a coated polypropylene (abbreviated as PP in FIG. 1) as the external layer or layer closest to the environment (designated as 1 in FIG. 1), followed by a cu-layer with DLC coating (designated as 2 in FIG. 2) and a non-woven layer (designated as 3 in FIG. 1). Layer 3 will be closest to the human being. The filter just described corresponds to Hy-Cu 3-layer shown in FIG. 3. Alternatively, filter 130 can also be the 5-layer Hy-Cu filter shown in FIG. 3. It is to be noted that filter 130 can be removed from pocket 120 and replaced as needed. As a non-limiting example, example a 3-layer Hy-Cu filter can be replaced by another 3-layer HY-Cu filter or a 5-layer Hy-Cu filter.

Based on the above, it is an objective of this disclosure to describe a mask assembly comprising a face covering portion, a pocket connected to the face portion and positioned to cover a wearer’s nose and mouth, where in a filter is removably inserted into the pocket, the filter comprising a porous hydrophobic and lipophobic layer, a diamond - like carbon coated copper layer, and a non- woven fabric layer. FIG. 17 is an exemplary and non-limiting embodiment of the mask assembly described above while FIG. 1 shows an exemplary configuration of the 3-layer filter of this disclosure.

In some embodiments of the ask assembly of this disclosure, the porous hydrophobic and lipophobic layer is a hydroxylated polypropylene surface having chemically attached siloxane molecules, and has a thickness in the range of 0.2-0.8 mm. In some embodiments of the mask assembly of this disclosure, the diamond-like carbon of the diamond-like carbon coated copper layer is impregnated with clusters selected from a list consisting of zinc oxide, silver nanoparticles, and a combination of zinc oxide and silver nano particles. In some embodiments of the mask assembly of this disclosure, the filter has three layers, where in the external layer is the porous hydrophobic layer, followed immediately by the diamond-like carbon coated copper layer positioned, followed by a non-woven layer. In some embodiments of the mask assembly, the non - woven fabric layer has a thickness in the range of 0.1-0.5 mm. In some embodiments of the mask assembly, the diamond - like carbon coated copper layer has a thickness in the range of 0.5.-0.8 mm. In some embodiments of the mask assembly, the filter further comprises a connector for attaching the filter to the face covering portion. Materials suitable for the connector include, but not limited to tape, adhesive, hooks, and hook and loop connectors. In some embodiments, the filter further comprises a frame portion for supporting multiple filter layers.

It is another objective of this disclosure to describe a filter containing at least one porous hydrophobic and lipophobic layer, at least one diamond - like carbon coated copper layer interposed between two non-woven fabric layers, and at least one additional non - woven fabric layer. In some embodiments of the filter of this disclosure, the non - woven fabric layer has a thickness in the range of 0.1-0.5 mm. In some embodiments of the filter of this disclosure, the diamond - like carbon coated copper layer has a thickness in the range of 0.5.-0.8 mm. In some embodiments of the filter of this disclosure, the filter contains a frame portion operationally connected to hold the respective layers, and a connector operationally connected to the frame portion for connecting the filter to the mask. In some embodiments of this filter of this disclosure, the total thickness of the filter is in the range of 1.0-3.0 mm.

While the present disclosure has been described with reference to certain embodiments, it will be apparent to those of ordinary skill in the art that other embodiments and implementations are possible that are within the scope of the present disclosure without departing from the spirit and scope of the present disclosure. Thus, the implementations should not be limited to the particular limitations described. Other implementations may be possible. It is therefore intended that the foregoing detailed description be regarded as illustrative rather than limiting. Thus, this disclosure is limited only by the following claims.

1. A mask assembly comprising a face covering portion, a pocket connected to the face portion and positioned to cover a wearer’s nose and mouth, where in a filter is removably inserted into the pocket, the filter comprising a porous hydrophobic and lipophobic layer, a diamond - like carbon coated copper layer, and a non- woven fabric layer.

2. The mask assembly of claim 1 wherein the porous hydrophobic and lipophobic layer is a hydroxylated polypropylene surface having chemically attached siloxane molecules, and has a thickness in the range of 0.2-0.8 mm.

3. The mask assembly of claim 1 wherein the diamond like carbon of the diamond-like carbon coated copper layer is impregnated with clusters selected from a list consisting of zinc oxide, silver nanoparticles, and a combination of zinc oxide and silver nano particles.

4. The mask assembly of claim 1 wherein the filter has three layers, where in the external} layer is the porous hydrophobic layer, followed immediately by the diamond-like carbon coated copper layer positioned, followed by a non-woven layer.

5. The mask assembly of claim 1, wherein the non - woven fabric layer has a thickness in the range of 0.1-0.5 mm.

6. The mask assembly of claim 1, wherein the diamond - like carbon coated copper layer has a thickness in the range of 0.5.-0.8 mm.

7. The mask assembly of claim 1, wherein the filter further comprises a connector for attaching the filter to the face covering portion.

8. The mask assembly of claim 7, wherein the connector is selected from the group consisting of tape, adhesive , hooks , and hook and loop connectors.

9. The mask assembly of claim 1, wherein the filter further comprises a frame portion for supporting multiple filter layers.

10. A filter comprising:
at least one porous hydrophobic and lipophobic layer;
at least one diamond - like carbon coated copper layer interposed between two-non woven fabric layers; and
at least one additional non - woven fabric layer.

11. The filter of claim 10, wherein the non - woven fabric layer has a thickness in the range of 0.1-0.5 mm.

12. The filter of claim 10, wherein the diamond - like carbon coated copper layer has a thickness in the range of 0.5.-0.8 mm.

13. The filter of claim 10, further comprising a frame portion operationally connected to hold the respective layers, and a connector operationally connected to the frame portion for connecting the filter to the mask.

14. The filter of claim 5, wherein the total thickness of the filter is in the range of 1,0-3,0 mm.

15. A filter comprising:
at least one porous hydrophobic and lipophobic layer;
at least one diamond - like carbon coated copper layer; and
at least one non - woven fabric layer,
wherein the at least diamond-like carbon coated layer is between the at least one porous hydrophobic and lipophobic layer and the at least one non - woven fabric layer.
